(19) United States
(12) Patent Application Publication
(10) Pub. No.: US 2009/0100789 A1
(43) Pub. Date: Apr. 23, 2009

(54) Support stand to hold a post and kit for manufacturing the same

(76) Inventors: Tim Hornbeak, Nashville, TN (US); Keith Tucker, Greenfield, TN (US); Milton Smith, Brentwood, TN (US)

Correspondence Address: Mark D. Jenkins, 8009 Tyson Oaks Circle, Vienna, VA, 22182, US

(21) Appl. No.: 11/975,561

(22) Filed: Oct. 22, 2007

(51) Int. Cl. E04B 1/35; E04C 3/34; F16M 13/00

(52) U.S. Cl. 52/745.19; 248/519

(57) ABSTRACT

The present invention provides a support stands as well as kits and methods for manufacturing the support stand that holds an elongate pole. In one embodiment, the stand comprises container receives a dish and a plurality of handle molds with one of a plurality of molds selectively positioned on the dish to define a cavity for the pole, for receiving a curable mixture to form the support stand, and optionally, a release solution applied to interior surfaces and, optionally, a plurality of mesh screens disposed in spaced-apart relation in the container. In an alternative embodiment, the stand comprises a container capable of receiving a filler, a removable lid, and a sleeve positioned within the container and conforming in cross-section to a post for being supported by the container. A kit for each stand and a method of manufacturing the support stands are disclosed.

### CROSS-REFERENCE TO RELATED APPLICATIONS

The present application claims priorty from provisional application No. 60/562,158 filed Oct. 19, 2007.

### BACKGROUND OF THE INVENTION

1. Field of the Invention

The present invention relates to holders for posts. More particularly, the present invention relates to support stands for posts as well as kits and methods for building support stands for posts.

2. Description of Related Art

Inserting a post into the earth can be a difficult task due to certain characteristics associated with various soil surfaces and substrates. For instance, some areas have soil that is not easily removed by manual labor due to the presence of aggregates such as rocks or stones. Other areas may have various obstructions that cause difficulty in forming holes. The obstructions include tree roots, plumbing and sprinkler systems as well as in-ground utility lines. Other soils have high sand content which is unsatisfactory for firmly supporting a post. As such, it may be difficult, if not impossible for a person to install a support for fencing, lighting, sports equipment, signage or other various applications where a support such as a post or pole is needed.

To accommodate difficult post mounting conditions, various types of metal or plastic portable support stands have been employed. Unfortunately, these systems may require professional installation or be incapable of withstanding extreme weather such as high or low temperature or high winds. Over the years, the use of concrete has proven to be dependable for such applications. Concrete mix products are available generally at builder's supply stores. A laborer is thus presently relegated to digging a hole in the ground, placing the support in the hole, pouring a wet cementations mixture into the hole around the post, and waiting for the cement mixture to cure around the support, in order to secure the support on the post in the ground. However, to move the support, the laborer must dig the concrete support out of the ground. This often proves to be an arduous task. There exists a need in the art for an apparatus as well as a kit and method for a laborer to construct a support stand that allows posts to be set into the stand and selectively removed or placed in the ground. It is to such that the present invention is directed.

### SUMMARY OF THE INVENTION

The present invention meets the need in the art by providing a support stand for a post. In one embodiment the support stand comprises a container for receiving a curable material to form a support stand for a post with a dish for being disposed in a bottom portion of the container. A plurality of handle forms are selectively positioned within the container for defining recesses in the support stand. A mold is positioned within the container and conforming in cross-section to a post for being supported by the support stand. A curable material, cured within the container forms a molded support stand for holding the post. A kit for consumer purchase comprising the support stand is also provided.

In another aspect, the present invention provides a method of building a support for an elongated member comprising the steps of:
(a) providing a container;
(b) positioning a dish in a bottom portion of the container;
(c) positioning a mold on the dish;
(d) positioning a pair of handle molds on opposing perimeter portions of the dish;
(e) pouring a curable material into the container around the mold;
(f) allowing the curable material to cure to form a solidified support stand;
(g) removing the support stand from the container;
(f) positioning an elongated member in a cavity defined by removal of the mold; whereby the support stand, positioned on the ground, supports the elongated member.

In an alternative embodiment, the present invention provides a support stand for a post, comprising a container capable of receiving a filler, a removable lid, and a sleeve positioned within the container and conforming in cross-section to a post for being supported by the container. In one aspect the filler is a curable material that, when cured within the container, forms a molded support stand for holding a post. In another aspect, the curable material comprises a mixable concrete material. The filler can also be at least one rock, sea shell, sand particle, marble, water, gold fish or a combination thereof. Alternatively, the removable lid and sleeve are one solid piece. The support stand can further comprise a sleeve holder or a sleeve plug. In one aspect, the container comprises a substantially rouinded bottom. A kit for consumer purchase comprising the support stand is also provided.

In another aspect, a method of building a support stand for an elongated member is provided comprising the steps of:
(a) providing a container;
(b) positioning a sleeve in a center portion of the container;
(c) pouring a filler into the container around the sleeve;
(d) positioning an elongated member in sleeve; whereby the support stand supports the elongated member.

The method can further comprise the steps of pouring a curable material into the container, allowing the curable material to cure to form a solidified support stand, removing the curable material from the container, and positioning the support stand in the ground. In one aspect, the curable material comprises a cementations mixture. Alternative, the container can receive a filler. The filler can be at least one rock, sea shell, sand particle, marble, water, gold fish or a combination thereof.

Objects, advantages, and features of the present invention will become readily apparent upon reading the following detailed description in conjunction with the drawings and the appended claims.

### BRIEF DESCRIPTION OF THE DRAWINGS

FIG. 1 illustrates a temporary fence using support stands.

FIG. 2 illustrates in detailed perspective view a support stand having a mold exploded away from the stand.

FIG. 3 illustrates in detailed perspective view an embodiment of a stand for an elongated post.

FIG. 4 illustrates in detailed perspective view an alternate embodiment of the stand illustrated in FIG. 3.

FIG. 5 illustrates in detailed perspective view yet another alternative embodiment of the stand.

### DETAILED DESCRIPTION OF THE INVENTION

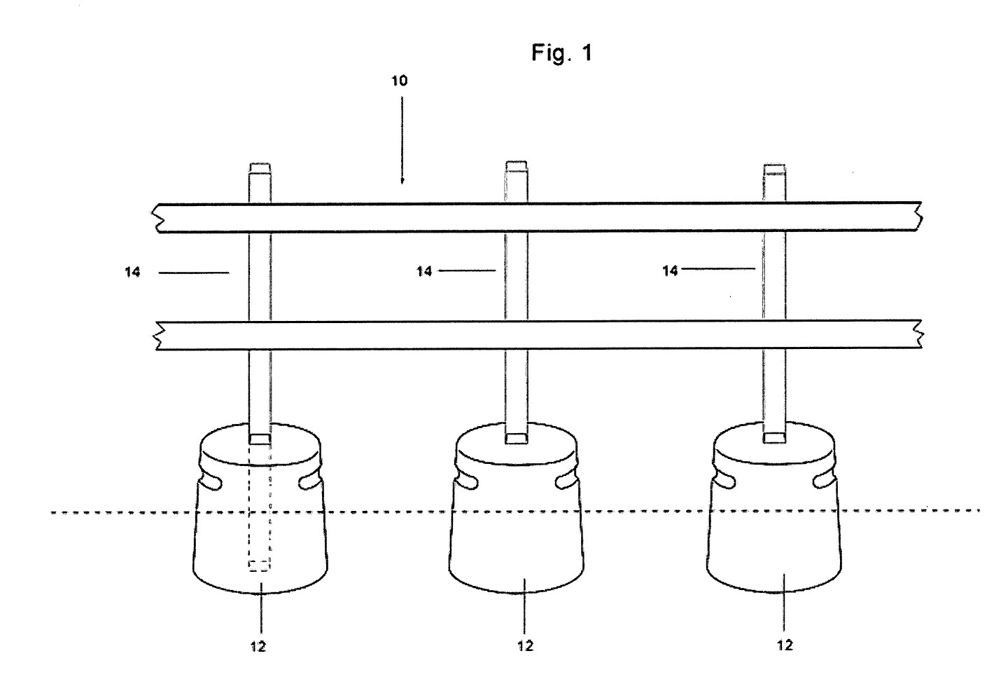

With reference to the drawings, in which like parts have like reference numerals, FIG. 1 illustrates a temporary fence 10 using support stands 12. In this embodiment, the support stands 12 are placed above ground and receive elongated posts 14 that are substantially rectangular in shape. The elongated posts 14 serve as fencing. In an alternate embodiment, the stand 12 holds an elongated post for the purpose of lighting, sports equipment, signage, or other post functions.

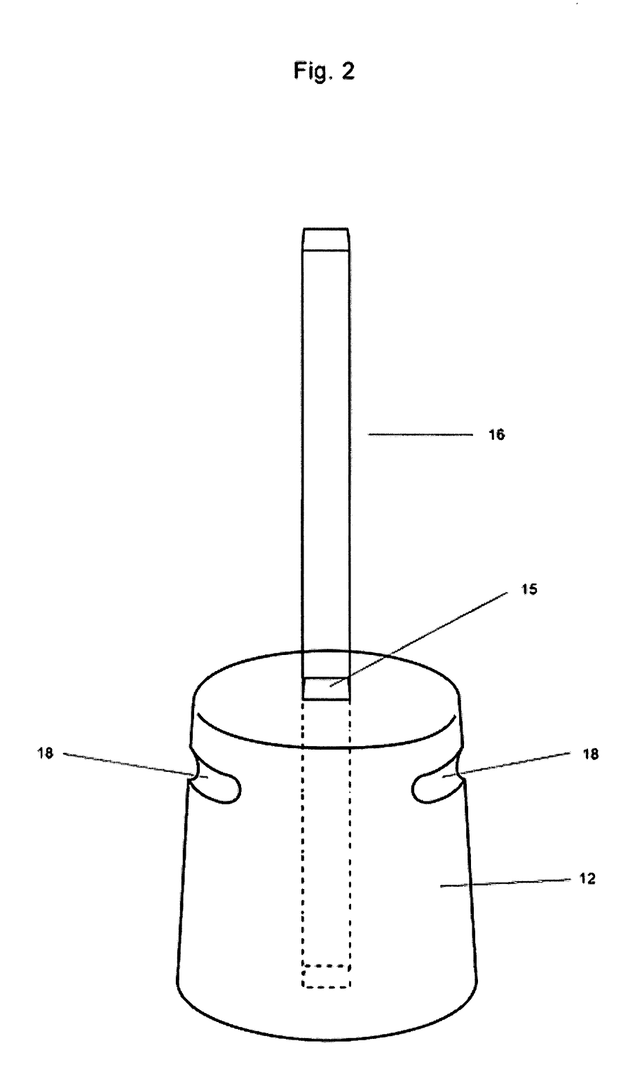

FIG. 2 illustrates in detailed perspective view the support stand 12 having a mold 16 exploded away from the stand 12. The mold 16 is substantially the same shape and size of the elongated post 14 received by the stand 12 as described below. The mold 16 defines a cavity 15 in the stand 12 to receive the post 14. As illustrated, recesses 18 in a bottom portion of the support stand 12 provide gripping places for the hands and fingers during lifting. Alternatively, the recesses 18 may be formed intermediate a bottom and a top portion of the support stand 1 2 to facilitate lifting, rolling, or moving the support stand 12.

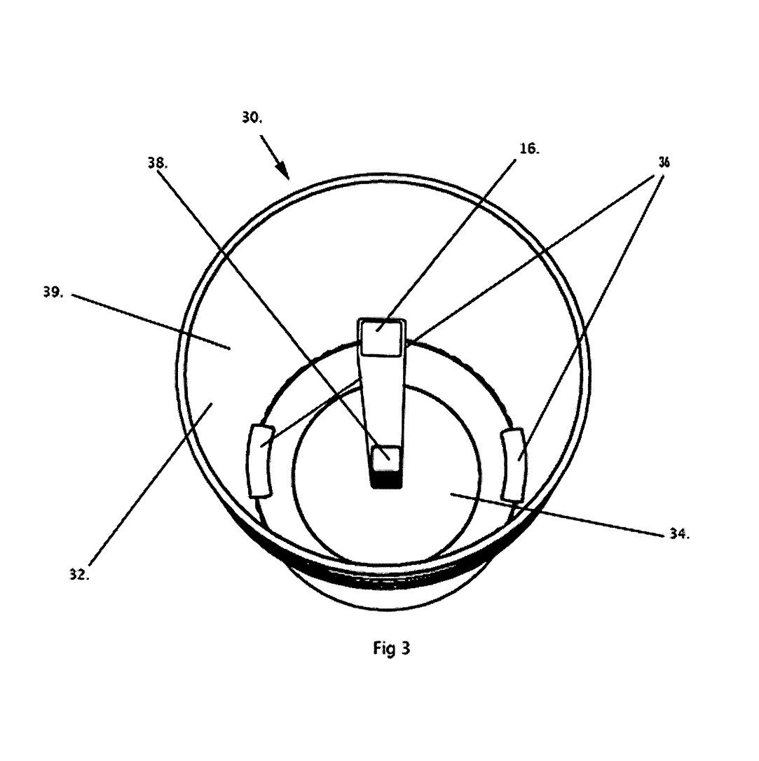

FIG. 3 illustrates in detailed perspective view of an embodiment of a resulting support stand 30 for on-site manufacture. The numeral “30” is understood to indicate the resulting support stand as indicated in FIGS. 1 and 2 as “12.” The support stand 30 comprises a container 32 that receives a dish 34. The container 32 can have a closed bottom, or an open bottom that is closed by the dish 34. A plurality of handle molds 36 sit in a lower portion of the container 32 on the dish 34.

A mold holder 38 attaches to a center portion of the base and engages the post mold 16. In one embodiment, a fastener extends through the dish 34 into the mold 16 to secure the mold within the container 32. A concrete release solution 39 may be applied to the sides of the container 32. These components are readily provided in a kit configured for purchase and manufacture of a stand 30.

The container 32 can have a standard capacity of five gallons; however, various capacities and shapes may be employed depending on the desired size and shape of the support to be manufactured. Preferably, the container 32 is made of plastic; however, it is within the scope of this disclosure to include a container 32 made of any material capable of holding a curable materials mix for manufacture of the stand 30, such as cementations mix. Suitable container materials include polyvinylchloride, metal and metal alloys. The container 32 may contain a closed or open bottom that receives a dish 34 having structural dimensions adapted to the diameter and overall shape of the container 32. An open-bottom container facilitates extraction of the stand and the dish once the stand 30 has cured as discussed below. The dish 34 is made of a metal or metal alloy capable of supporting the weight or pressure of the cementations mixture.

In the illustrated embodiment, the two handle forms 36 rest on an outer peripheral edge of the dish 14. When the cementations mix is poured into the container 32, the forms 36 define the cavities or recesses 18 the forms 36. The forms 36 are fabricated from foam rubber or wood blocks; however, the forms 36 may be comprised of any materials that can withstand the pressure and acidity of the concrete mix. The recesses 18 formed by these forms 36 allow the laborer to physically grip the support 12 to facilitate lifting, carrying, and moving the support. A mold holder 38 attaches to a center portion of the dish 34. The mold holder 38 holds the mold 16 in position to define the receiving cavity that conforms to the cross-sectional shape of the elongated post 14 to be positioned in the stand 30. A toggle bolt or other fastener used as the molder holder 38 accepts various sized molds 16.

In an alternative embodiment, the mold 16 is an elongaged block of wood positioned in a center portion of the dish 34. The mold 16 slideably engages the mold holder 38 in a center portion of the dish 34. The mold 16 is substantially the same length as the depth of the respective container. The mold 16 is made of waxed cardboard for easy removal. The mold 16, however, may be fabricated from any durable material such as polyvinylchloride, metal and metal alloys.

Once the cementatious mixture cures, the mold 16 is removed. The cavity defined by the mold 16 is dimensioned to slideably receive the post 14, pole or other structure to be held by the support 30 (i.e,. “12” of FIGS. 1 and 1). A commercial embodiment of the support stand 30 includes a plurality of molds 16. Each mold 16 corresponds to a standard support such as a 2″×2″ or 4×4″ square 20 posts or a round post having a diameter of 1″, 1½″, 2″, 2½″, or 3.″

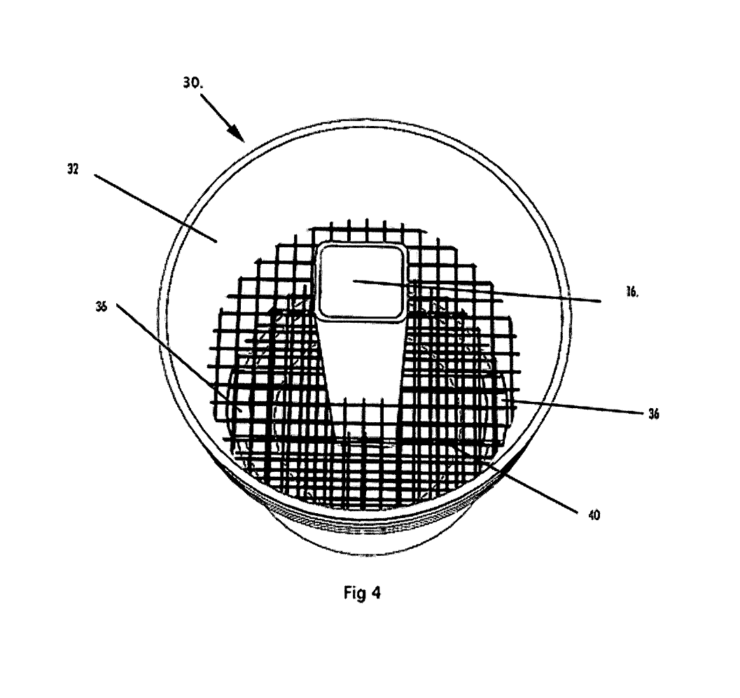

FIG. 4 illustrates an alternative embodiment of the support stand 30 of FIG. 3. In this embodiment, the support stand 30 includes a plurality of mesh screens 40 annularly surrounding the mold 16. Preferably, a plurality of mesh screens 40 is placed at spaced positions along the interior of the container 32. In one embodiment, the mesh screens 40 are fabricated from woven or welded galvanized aluminum. In the illustrated embodiment, ½″ mesh is utilized. The mesh screens 40 have a multi-function purpose. In one aspect, the mesh screens 40 act as a support strengthening agent for the concrete. In another aspect, slots cut out of a middle portion of the mesh screens 40 act as an alignment tool for the mold 16. The release solution 39 coats the inner surface of the container. The release solution 39 for cementations mixtures is a silicon-based solution, such as Concrete Form Release Agent made by Encor in Nashville, Tenn. It is understood, however, that the release solution 39 could be any comparable coating solution known in the art. The release solution 39 allows the cured concrete formation to be easily removed from the container 32.

With reference to FIGS. 3 and 4, the support stand 12 is manufactured with the support stand 30. The container 32 has a capacity substantially equal to the size of the support 30 needed. The mold 16 attaches with the fastener to the dish 34. The dish 34 positions in a bottom portion of the container 32. The handle forms 36 are placed on the perimeter portions of the dish 34. As an optional step, a user engages at least one mesh screen 40 annular to the mold 16. For further reinforcement, the user may arrange multiple mesh screens 40 spaced-apart in the container. With the components of the support stand 30 positioned, a user pours a curable material such as a pre-mixed cementatious mixture into the container 32 and around the mold 16. With use of the mesh screens 40, the mixture falls through the screens and fills the container 32. The curable material cures within the container 32. A cementation mixture typically cures in about twenty-four hours. The cure time depends on the weather conditions at pouring. After 15 curing, the user removes the mold 16 leaving the cavity adapted to receive the elongated pole or post 14.

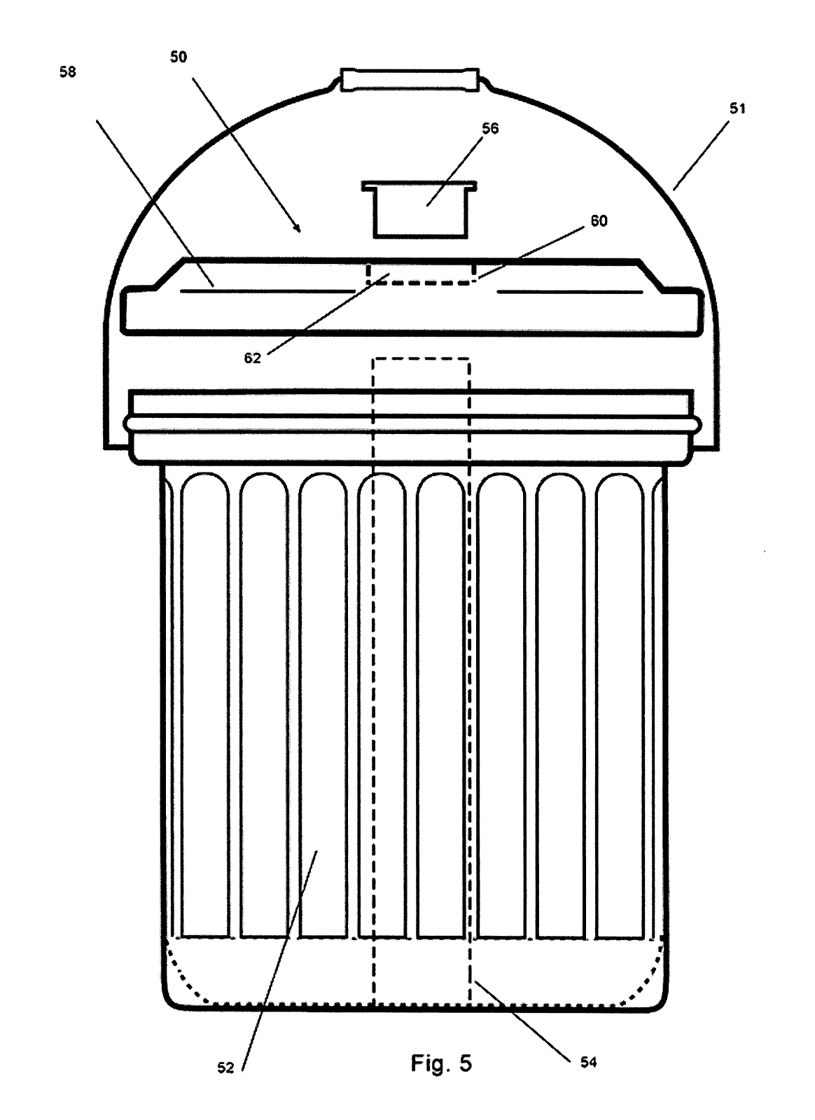

FIG. 5 illustrates in detailed perspective view yet another alternative embodiment of the support stand 50. In this embodiment, the support stand comprises a container 52 of substantially the same capacity of the containers previously described. The support stand further comprises a sleeve 54, a removable lid 58 and, optionally, a sleeve holder 60 and a sleeve plug 56. Preferably, the container 52 has a capacity of about 4 gallons. The sleeve 54 resides within a central portion of the container 52. The removable lid 58 comprises a cavity 62 located substantially in a center region of the lid 58. The removable lid 58 substantially engages the top rim of the container 52. As illustrated, the interior of the container 52 has a substantially rouinded bottom or “bullet” shape. Should the user choose to pour concrete within the container 52, this shape results in a rounded mold. The bullet shape up may be more appealing for above-ground applications, since sharp corners can be rough if the concrete is poured in a square-bottomed embodiment of the container 52. However, it is within the scope and spirit of the invention that the bottom of the container be square in shape, especially for applications where the user places the container 52 in the ground and later chooses to pull the container out of the ground. A handle 51 is attached to help a user move the stand 50 from place to place.

The sleeve holder 60 is preferably engaged in the cavity 62 to secure the sleeve 54. The sleeve plug 56 is placed above the cavity 62 to cover the sleeve 54 when pouring a filler such as concrete, sand, water, etc. into the container 52. The sleeve plug 56 also serves an aesthetic purpose (i.e., to conceal the sleeve when no post inserted in sleeve). The removable lid 58 covers the filler and gives a more pleasing appearance, especially when the container 52 is utilized above ground.

Preferably, the removable lid 58, sleeve 54 and container 52 are fabricated of a plastic, preferably clear plastic; however, it is within the scope of this disclosure to include a removable lid 58, sleeve 54 and container 52 made of any material capable of holding a filler such as a curable cementatious mix. Both the removable lid 58 and container 52 are reusable. In one embodiment, the removable lid 58 is a clear plastic to allow viewing of a decorative filler, such as rock sea shells, colored sand, marbles, colored water, gold fish and the like. The removable lid 58 and container 52 can be fabricated in a variety of sizes to accommodate various sized posts. A complimentary sized sleeve 54 can be fabricated to selectively engage each removable lid 58 and container 52. The advantage of this embodiment is that this embodiment eliminates the need for recesses and plugs. Furthermore, the need to separate the concrete from the container 52 is eliminated.

In use, the user inserts the sleeve 54 within a center portion of the container 52. Next, the pours a filler in the areas outside the sleeve 54 (i.e., within the container 52) up to a level found acceptable by the user. The amount of filler poured within the container 52 will vary based on the size of the container 52 and the weight needed to support the post. A post is then inserted within the sleeve 54 which is substantially adapted to receive the post. The overall shape of the container 52 and lid 58 allows both pieces to be pulled out of the ground by using a noose like rope or cable wrapped around the outside perimeter of the container 52. For above-ground applications, the container 52 may be left in place such as when the filler is sand or water. For in-ground applications, the container can optionally be removed or placed in the ground as a whole.

In an alternative embodiment, the sleeve 54 and removable lid 58 comprise one solid piece with an additional outside plastic corrugated sleeve 64 around the perimeter of the sleeve 54. In use, the solid piece would be pushed down into the concrete and after the concrete hardens allowing the user to then pull the sleeve 54 and removable lid 58 piece out and leave the plastic outside sleeve behind thus defining a space capable of receiving a post. All embodiments are made available in the form of a kit for consumer purchase.

While this invention has been described in detail with particular references to illustrated embodiments thereof, it should be understood that many modifications, additions and deletions, in additions to those expressly recited, may be made thereto without departure from the spirit and scope of the invention.

1. A support stand for a post, comprising:
a container for receiving a curable material to form a support stand for a post;
a dish for being disposed in a bottom portion of the container;
a plurality of handle forms selectively positioned within the container for defining recesses in the support stand; and
a mold positioned within the container and conforming in cross-section to a post for being supported by the support stand, whereby a curable material, cured within the container forms a molded support stand for holding a post.

2. The support stand as recited in claim 1, wherein the curable material comprises a mixable concrete material.

3. The support stand as recited in claim 2, further comprising a concrete valise solution for being applied to an interior wall of the container to facilitate removal of the stand upon cure of the concrete material.

4. The support stand as recited in claim 1, further comprising at least one mesh screen received within the container about the mold, to provide structural support for the concrete.

5. A kit for consumer purchase comprising the support stand of claim 1.

6. A method of building a support stand for an elongated member, comprising the steps of:
(a) providing a container;
(b) positioning a dish in a bottom portion of the container;
(c) positioning a mold on the dish;
(d) positioning a pair of handle molds on opposing perimeter portions of the dish;
(e) pouring a curable material into the container around the mold;
(f) allowing the curable material to cure to form a solidified support stand;
(g) removing the support stand from the container;
(f) positioning an elongated member in a cavity defined by removal of the mold; whereby the support stand, positioned on the ground, supports the elongated member.

7. The method as recited in claim 6, wherein the curable material comprises a cementatious mixture.

8. The method as recited in claim 6, further comprising the step of positioning at least one mesh screen within the container about the mold prior to step (e) to provide an internal support structure for the stand.

9. A support stand for a post, comprising:
a container capable of receiving a filler;
a removable lid; and
a sleeve positioned within the container and conforming in cross-section to a post for being supported by the container.

10. The support stand as recited in claim 9, wherein the filler is a curable material that, when cured within the container, forms a molded support stand for holding a post.

11. The support stand as recited in claim 10, wherein the curable material comprises a mixable concrete material.

12. The support stand as recited in claim 9, wherein the filler is selected from the group consisting of rock, sea shells, sand, marbles, water, gold fish and a combination thereof.

13. The support stand as recited in claim 9, wherein the removable lid and sleeve are one solid piece.

14. The support stand as recited in claim 9, further comprising a sleeve holder.

15. The support stand as recited in claim 9, further comprising a sleeve plug.

16. The support stand as recited in claim 9, wherein the container comprises a substantially rouinded bottom.

17. The support stand as recited in claim 9, further comprising an additional outside plastic corrugated sleeve around the perimeter of the sleeve.

18. A kit for consumer purchase comprising the support stand of claim 9.

19. A method of building a support stand for an elongated member, comprising the steps of:
(a) providing a container;
(b) positioning a sleeve in a center portion of the container;
(c) pouring a filler into the container around the sleeve; and
(d) positioning an elongated member in sleeve; whereby the support stand supports the elongated member.

20. The method of claim 19, further comprising the steps of pouring a curable material into the container; and allowing the curable material to cure to form a solidified support stand.

21. The method of claim 20, further comprising the step of removing the curable material from the container.

22. The method as recited in claim 20, wherein the curable material comprises a cementatious mixture.

23. The method of claim 19, further comprising the step of positioning the support stand in the ground.

24. The method of claim 19, wherein the filler is selected from the group consisting of rock, sea shells, sand, marbles, water, gold fish and a combination thereof.
